(19) United States
(12) Patent Application Publication
(10) Pub. No.: US 2011/0050496 A1
(43) Pub. Date: Mar. 3, 2011

(54) Energy Domain Based Peak Reconstruction Methods And Apparatuses

(75) Inventors: Jie Wu, San Diego, CA (US); Emilija Simic, La Jolla, CA (US)

(73) Assignee: QUALCOMM Incorporated, San Diego, CA (US)

(21) Appl. No.: 12/574,625

(22) Filed: Oct. 6, 2009

Related U.S. Application Data
(60) Provisional application No. 61/239,344, filed on Sep. 2, 2009.

(51) Int. Cl. G01S 19/37

(52) U.S. Cl. 342/357.77

(57) ABSTRACT

Methods and apparatus are provided for use in devices enabled to perform waveform correlation processing of satellite positioning system (SPS) signals, including peak reconstruction.

### CLAIM OF PRIORITY UNDER 35 U.S.C. §119

The present application for patent claims priority to U.S. Provisional Application No. 61/238,344 entitled “Energy Domain Based Peak Reconstruction Methods And Apparatuses”, filed Sep. 2, 2009, assigned to the assignee hereof and hereby expressly incorporated by reference herein.

### BACKGROUND

1. Field

The subject matter disclosed herein relates to electronic devices, and more particularly to methods and apparatuses for use in electronic devices enabled to perform waveform correlation processing of satellite positioning system (SPS) signals, including energy domain based auto-correlation peak reconstruction.

2. Information

Among the popular and increasingly important wireless technologies today are navigation systems and like configured devices and in particular those devices that acquire signals from satellite positioning systems (SPS) such as, for example, the global positioning system (GPS) and other like Global Navigation Satellite Systems (GNSS), and based on those acquired signals estimate a location of the device. An SPS receiver, for example, may receive wireless SPS signals that are transmitted by a plurality of orbiting satellites of a GNSS. The SPS signals once received may be processed, for example, to determine a global time, an approximate geographical location, altitude, and/or speed associated with a device having an SPS receiver.

An SPS receiver and/or other similar equipped electronic devices may be enabled to perform waveform correlation and/or other like processes that allow for a specific wireless signal to be identified within a received waveform which may include noise and other signals. An SPS receiver may, for example, be enabled to receive a sample received waveform which may or may not include an SPS signal having a particular code phase. The sample received waveform may be compared to plurality of phase shifted replica waveforms, for example, through a correlation process to provide a plurality of energy samples which may be associated with a code phase domain and Doppler bins. In this manner a plurality of hypothesis may be tested in an attempt to identify peak values associated with a time and/or frequency uncertainty. Once identified, a peak value may be used in further attempts to acquire an SPS signal and/or to otherwise perform various location/position related processes.

### SUMMARY

Some example methods and apparatuses are provided herein which may be enabled within and/or for use with a Satellite Positioning System (SPS) receiver and/or other like apparatuses or device(s) to perform waveform correlation processing of SPS signals, and in particular to perform and/or otherwise support auto-correlation peak reconstruction processing.

By way of example but not limitation, in accordance with certain aspects a method is described which may be implemented for use in and/or with a Satellite Positioning System (SPS) receiver. The method may include, for example, determining one or more likelihood metrics between at least two energy samples and at least two samples associated with a corresponding plurality of hypothesis tests associated with an expected curve for the SPS receiver. Here, for example, the two energy samples may be sampled at a first rate by the SPS receiver. In certain example implementations, a first rate may be a chip×1 rate associated with a chip rate for an SPS signal.

The method may include determining an estimated sampling phase associated with the two energy samples based, at least in part, on the determined likelihood metrics. The method may also include determining an estimated peak energy value associated with a plurality of energy samples based, at least in part, on the expected curve and the estimated sampling phase. The method may further include estimating a code phase for a received SPS signal based, at least in part, on the estimated sampling phase in a time domain, and/or a Doppler for the received SPS signal based, at least in part, on the estimated sampling phase in a frequency domain. In certain example implementations, e.g., with respect to the time domain, an expected curve may include an autocorrelation function (ACF) curve.

In certain example implementations, an estimated peak energy value may include a reconstructed peak energy value for use in detection, and/or a reconstructed peak energy value for use in C/Nₒ estimation. In certain example implementations, the method may further include providing an estimated peak energy value as a reconstructed peak energy value for use in C/Nₒ estimation (e.g., if an estimated peak energy value exceeds a minimum threshold value). In certain example implementations, the method may further include selectively determining an estimated peak energy value to provide a reconstructed peak energy value for use in either detection or C/Nₒ estimation.

In certain example implementations, the method may further include one or more of: normalizing at least two energy samples; adjusting the at least two energy samples based, at least in part, on a mean noise energy value; and/or determining that at least one of the two energy samples exceeds a minimum threshold value before determining a likelihood metric.

In certain example implementations, the two energy samples may be associated with a code phase domain portion of a search grid comprising a cluster of energy samples that are also associated with Doppler bins.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is block diagram illustrating an exemplary wireless signaling environment that includes a device enabled to perform waveform correlation processing including auto-correlation peak reconstruction in accordance with an implementation.

FIG. 2 is block diagram illustrating certain features of an exemplary device enabled to perform waveform correlation processing including auto-correlation peak reconstruction that may, for example, be implemented in the environment of FIG. 1.

FIG. 3 is an illustrative diagram showing an example cluster of peak energies of a search grid supportive of waveform correlation processing including auto-correlation peak reconstruction, for example, as may be implemented in the environment of FIG. 1.

FIG. 4 is an illustrative graph showing an example likelihood of detection on a autocorrelation function associated with waveform correlation processing including auto-correlation peak reconstruction, for example, as may be implemented in the environment of FIG. 1.

FIG. 5 is a flow diagram illustrating an exemplary method for performing waveform correlation processing including auto-correlation peak reconstruction that may, for example, be implemented in the environment of FIG. 1.

### DETAILED DESCRIPTION

Some example methods and apparatuses are provided herein which may be enabled within and/or for use with a Satellite Positioning System (SPS) receiver and/or other like apparatuses or device(s) to perform waveform correlation processing of SPS signals, and in particular to perform and/or otherwise support auto-correlation peak reconstruction processing.

An SPS receiver may, for example, be enabled to search for SPS signals, acquire SPS signals and possibly track SPS signals. To search for an SPS signal, a search space may be established which includes time and frequency uncertainty information that may be logically arranged in a grid pattern. Here, for example, a time uncertainty may be partitioned into a plurality of hypothesis. Correlators (e.g., as provided within correlation circuitry) may be used to provide correlation results for each hypothesis. Typically, such hypotheses are in steps of 1/N of the SPS chip, wherein N is an integer greater than or equal to two. Having a higher sample rate (e.g., higher N) tends to reduce energy losses due to sampling time misalignment, for example. However, there may be a penalty with a higher sample rate in that the time to finish all correlations tends to increase for given total number of correlators, which tends to result in a longer time-to-fix.

Consequently, it may be beneficial to reduce search times, processing requirements, circuit requirements, power requirements, etc., by providing techniques that lower the sample rate (e.g., increase step size) of a time hypothesis to equal one SPS chip (period) (e.g., N=1). However, the average off-peak sampling loss may be significant which may lead to sensitivity loss and/or otherwise reduce effectiveness in deriving an accurate code phase (e.g., as may be used for ranging, and/or other like processes) and/or accurate signal to noise ratio (SNR) measurements (e.g., such as carrier signal to noise ratios C/Nₒ) from such ‘chip×1’ search results.

In accordance with certain aspects of the present description, certain example techniques are provided which may be implemented to reduce the effects of and/or essentially recover off-peak sampling losses and to derive sufficiently accurate measurements while utilizing a ‘chip×1’ search (e.g., hypothesis step size is one SPS chip) to achieve shorter time-to-fix. The techniques provided herein may prove to be particularly significant in reducing a time-to-fix delay if applicable SPS signals are relatively strong compared to the average noise level.

As described and illustrated in greater detail in subsequent sections herein, methods and apparatuses may be implemented wherein an input to a chip×1 peak energy reconstruction process may include a cluster portion of peak energies from a search grid, wherein a center energy may represent a ‘best’ peak detected in a grid. A row in such a cluster portion may represent Doppler bins containing the center energy, and a column in such a cluster portion may represent code phase bins containing the center energy. A peak energy reconstruction technique may be enabled to compute a likelihood between the two best chip×1 energies on the row and two one-chip spaced samples chosen from a known or otherwise predetermined autocorrelation function (ACF) curve. For example, after normalization, the two best chip×1 energies may be regarded as a first vector, and the two chip×1 samples from ACF curve may form a second vector. The distance between these two vectors may be calculated. By ‘moving’ the two chip×1 samples along the ACF curve (e.g., hypothesis testing), a position on ACF curve that minimizes the distance may be determined. This position on the ACF curve may be the estimated sampling phase for the chip×1 energies on the row. Since the sampling phase and ACF curve are known, one may then appropriately combine the chip×1 energies on the row to obtain a peak code phase location and/or peak height estimation.

In subsequent sections an example likelihood function (e.g., likelihood metric) is described in greater detail. As will be shown, two points (e.g., with chip×1 separation) may be chosen from a pre-determined ACF curve, these two points may be values with one code phase hypothesis. With the measured two peak energies, one may calculate a probability that the two measured peak energies are from the same code phase offset as the chosen two points from the ACF curve. This probability may be expressed, for example, as L₀ as subsequently described herein. Such probability may, for example, be referred to as a “likelihood”, or “likelihood metric”.

In certain examples, such probability may be inversely proportional to a distance of two sets of vectors. Hence, for example, a “maximum likelihood” may be identified by the smallest distance; e.g., one may look for a corresponding position on the ACF curve as a code phase. Thus, in certain example instances, a “likelihood metric” may be based, at least in part, on a distance of two vectors (for example, as subsequently expressed herein with L₁. As such, one may, for example, also equivalently consider a distance, e.g., L₁, as a likelihood metric. Here, for example, the probability may be maximum at a minimum distance.

Thus, by way of further introduction, as described and illustrated in greater detail in subsequent sections herein, certain example methods and apparatuses may be implemented to provide auto-correlation peak reconstruction techniques. For example, a method may include receiving and/or otherwise at least accessing a plurality of energy samples comprising at least two energy samples sampled at a first rate by the SPS receiver. The method may include determining likelihood metrics between the two energy samples and a plurality of at least two ACF samples associated with a corresponding plurality of hypothesis tests associated with an expected curve for a SPS receiver. The method may include determining an estimated sampling phase associated with the energy samples based, at least in part, on the calculated likelihood metrics, and determining an estimated peak energy value associated with the plurality of energy samples based, at least in part, on the expected curve and the estimated sampling phase. The method may include estimating a code phase for a received SPS signal based, at least in part, on the estimated peak energy value.

In certain example implementations, the estimated peak energy value may include a reconstructed peak energy value for use in detection processing. In certain other example implementations, the estimated peak energy value may include a reconstructed peak energy value for use in C/Nₒ estimation processing. In accordance with certain example implementations, the method may further include providing the estimated peak energy value as a reconstructed peak energy value for use in C/Nₒ estimation, if the estimated peak energy value exceeds a minimum threshold value. In accordance with certain example implementations, the method may further include selectively determining the estimated peak energy value to provide a reconstructed peak energy value for use in either detection processing or C/Nₒ estimation processing. Here, for example, such selection may depend on the applicable energy values, minimum threshold value, acceptable error parameters, time considerations, processing resource considerations, and/or other like factors.

In accordance with certain example implementations, the method may further include normalizing the two energy samples, and/or adjusting the two energy samples based, at least in part, on a mean noise energy value. In accordance with certain example implementations, the method may further include determining that at least one of the at least two energy samples exceeds a minimum threshold value before determining the likelihood metrics.

An energy sample may, for example, be output by a correlator for a specific code phase (time) offset and Doppler (frequency) offset. When searching for a signal, a receiver may generate many such energy samples at different code phase offsets and Doppler offsets (two dimensional). The code phase offset's step size may be 1 chip, or ½ chip, or 1/N chip. The Doppler offset's step size may be several Hz, for example, 25 Hz, 50 Hz, or Y Hz. Hence, for example, “energy samples” may include such energies as sampled 1/N chip in time domain and Y Hz in Doppler domain. Such energy samples may form an energy grid, for example, indexed by code phase offset in one dimension and Doppler offset in the other dimension. Generally, a search process tends to try to locate a maximum energy in an energy grid and its associated code phase offset and Doppler offset may represent the signal location.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Methodologies described herein may be implemented by various means depending upon applications according to particular features and/or examples. For example, such methodologies may be implemented in hardware, firmware, software, and/or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

The exemplary methods and apparatuses may be enabled to any electronic device. Examples of such devices herein include navigation and/or communication devices. However, claimed subject matter is not intended to be limited to just these examples.

With regard to certain exemplary navigation devices, a satellite positioning system (SPS) may include a system of transmitters positioned to enable entities to determine their location on the Earth based, at least in part, on signals received from the transmitters. Such a transmitter may transmit a signal marked with a repeating pseudo-random noise (PN) code of a set number of chips and may be located on ground based control stations, user equipment and/or space vehicles. A “space vehicle” (SV) as referred to herein relates to an object that is capable of transmitting signals to receivers on or above the Earth's surface. In one particular example, such an SV may include a geostationary satellite. Alternatively, an SV may include a satellite traveling in an orbit and moving relative to a stationary position on the Earth. However, these are merely examples of SVs and claimed subject matter is not limited in these respects.

In a particular example, such transmitters may be located on SVs such as Earth orbiting satellites. For example, a satellite in a constellation of a Global Navigation Satellite System (GNSS) such as Global Positioning System (GPS), Galileo, or Compass may transmit a signal marked with a PN code that is distinguishable from PN codes transmitted by other satellites in the constellation. In another example, a satellite in a constellation of a Global Navigation Satellite System (GNSS) such as GLONASS may transmit a signal marked with a same PN code as PN codes transmitted by other satellite in the constellation, but at a different frequency.

To estimate a location at a receiver, a device may be enabled to determine pseudorange measurements to SVs “in view” of the receiver using well known techniques based, at least in part, on detections of PN codes in signals received from the SVs. Such a pseudorange to an SV may be determined based, at least in part, on a code phase detected in a received signal marked with a PN code associated with the SV during a process of acquiring the received signal at a receiver. To acquire the received signal, a navigation device may be enabled to correlate a received waveform (e.g., received signal) with a generated waveform (e.g., locally generated PN code) associated with an SV. For example, such a navigation device may correlate such a received signal with multiple code and/or phase/time shifted versions (replica signals) of such a locally generated PN code. Detection of a particular time and/or code shifted version yielding a correlation result with the highest signal power may indicate a code phase associated with the acquired signal for use in measuring pseudorange as discussed above.

Upon detection of a code phase of a signal received from a GNSS SV, a receiver may form multiple pseudorange hypotheses, e.g., logically associated with a search grid or the like. Using additional information, a receiver may eliminate such pseudorange hypotheses to reduce an ambiguity associated with a true pseudorange measurement. With sufficient accuracy in knowledge of timing of a signal received from a GNSS SV, some or all false pseudorange hypotheses may be eliminated. For example, in certain implementations presented herein, as part of a signal acquisition process, a device may employ a chip×1 search to find a signal location, then the device may employ a chip×N (e.g., chip×2) search to determine a more accurate code phase of the signal. Thus, for example, a chip×1 search and reconstruction may be employed to quickly locate where a signal is with a coarse code phase and C/Nₒ estimate. Then if needed, a much finer resolution (such as chip×2) search may be employed for a narrower code phase space. Since this fine resolution search only searches for a very small code phase space, the time needed may be relatively short.

In the following detailed description, numerous specific details are set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

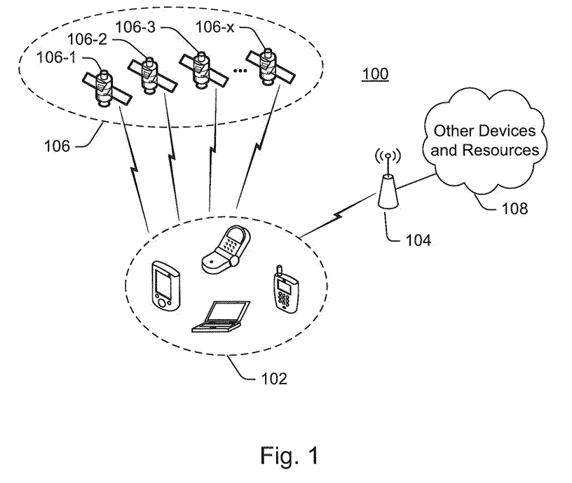

With this in mind, FIG. 1 is a block diagram illustrating a wireless environment 100 that may include various computing and communication resources. This example implementation may be enabled to provide at least some form of navigation services in accordance with certain exemplary implementations of present description. This example implementation may also and/or alternatively be enabled to provide at least some form of communication services in accordance with certain exemplary implementations of present description.

As for navigation services, for example, as shown in FIG. 1 an SPS 106 may include a plurality of SVs 106-1, 106-2, 106-3, . . . , 106-x that may transmit SPS signals to a device 102.

By way of example but not limitation, as illustrated using icons in FIG. 1, device 102 may include a mobile device such as a cellular phone, a smart phone, a personal digital assistant, a portable computing device, a navigation unit, and/or the like or any combination thereof. In other exemplary implementations, device 102 may take the form of a machine that is mobile or stationary. In still other exemplary implementations, device 102 may take the form of one or more integrated circuits, circuit boards, and/or the like that may be operatively enabled for use in another device.

In certain implementations wireless environment 100 may further include and/or alternatively include various computing and communication resources enabled to provide communication and/or other information processing services with respect to device 102. Thus, for example, wireless environment 100 may be representative of any system(s) or a portion thereof that may include at least one device 102 enabled to transmit and/or receive wireless signals to/from at least one wireless communication system 104.

As illustrated in FIG. 1, wireless communication system 104 may be enabled to communicate with and/or otherwise operatively access other devices and/or resources as represented simply by cloud 108. For example, cloud 108 may include one or more communication devices, systems, networks, or services, and/or one or more computing devices, systems, networks, or services, and/or the like or any combination thereof.

Device 102 may, for example, be enabled for use with various wireless communication networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), TD-SCDMA, to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example.

Device 102 may receive transmissions from SVs 106-1, 106-2, 106-3, . . . , 106-x, and derive time measurements from four or more of the transmissions, or less than four if other information is available, e.g., altitude information. At times, device 102 may receive transmissions from one or more of SVs 106-1, 106-2, 106-3, . . . , 106-x via a multipath route to device 102.

Techniques described herein may be used with any one of several SPS' and/or combinations of SPS'. Furthermore, such techniques may be used with positioning determination systems that utilize pseudolites or a combination of SVs and pseudolites. In still other examples, such techniques may be used with position determination systems that also utilize ground-based transmitters other than pseudolites, such as, for example, AFLT or Wi-Fi-based positioning determination systems. Pseudolites may include ground-based transmitters that broadcast a PN code or other ranging code (e.g., similar to a GPS or CDMA cellular signal) modulated on an L-band (or other frequency) carrier signal, which may be synchronized with system time. Such a transmitter may be assigned a unique PN code so as to permit identification by a remote receiver. Pseudolites may be useful in situations where SPS signals from an orbiting SV might be unavailable, such as in tunnels, mines, buildings, urban canyons or other enclosed areas. Another implementation of pseudolites is known as radio-beacons. The term “SV”, as used herein, is intended to include pseudolites, equivalents of pseudolites, and possibly others. The terms “SPS signals” and/or “SV signals”, as used herein, is intended to include SPS-like signals from pseudolites or equivalents of pseudolites.

With this in mind and in accordance with certain aspects, some exemplary methods and apparatuses will now be described, which may be implemented in one or more devices, such as device 102, to provide waveform correlation result processing.

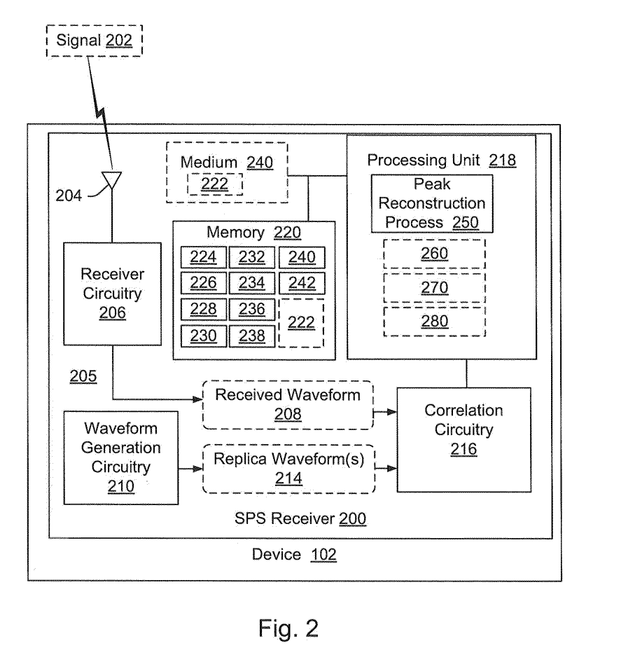

As illustrated in the exemplary block diagram of FIG. 2, in certain example implementations, device 102 may include an SPS receiver 200 enabled to receive a SPS signal 202. SPS receiver 200 may include at least one antenna 204 that may be operatively coupled to receiver circuitry 206, which may be enabled to receive wireless signal 202 and possibly other signals, noise, etc., and establish a corresponding received waveform 208. A waveform generation circuitry 210 may be enabled to establish a plurality of replica waveforms 214, which may be used for waveform correlation. Correlation circuitry 216 may be enabled to correlate at least received waveform 208 with one or more of the plurality of waveforms 214 to establish a corresponding plurality of correlation results, for example, a plurality of energy samples 224.

Various different types of correlation circuits are well known and which may be implemented within correlation circuitry 216. Correlation circuitry 216 may be implemented in hardware or a combination of hardware and software. By way of example but not limitation, correlation circuitry 216 may, for example, include one or more correlators, implement a discrete Fourier transform (DFT) function, and/or the like. In certain implementations, correlation circuitry 216 may include one or more processing units and specific instructions, and/or the like.

SPS receiver 200 may include, for example, one or more processing units 218 enabled to perform waveform correlation result processing in accordance with the present description. As shown, processing unit 218 may be operatively coupled to memory 220. Memory 220 may be enabled to store data signals and/or instructions. As shown in the example implementation of FIG. 2, memory 220 may be used to store data signals representing and/or otherwise operatively associated with a plurality of energy samples 224, one or more likelihood metrics 226, an expected (ACF) curve 228, at least two autocorrelation function (ACF) samples 230, an estimated sampling phase 232, an estimated peak energy value 234, a code phase 236, a reconstructed peak energy value 238, a minimum threshold value 240, a mean noise energy value 242, and/or instructions 222.

As illustrated in FIG. 2 an article of manufacture represented here by a computer readable medium 240 may be provided and accessed by processing unit 218, for example. As such, in certain example implementations, the methods and/or apparatuses may take the form in whole or part of a computer readable medium 240 that may include computer implementable instructions 222 stored thereon, which if executed by at least one processing unit or other like circuitry are enabled to enable the processing unit(s) 218 and/or the other like circuitry to perform all or portions of the waveform correlation result processes presented herein.

Processing unit 218 may be implemented in hardware or a combination of hardware and software. Processing unit 218 may be representative of one or more circuits configurable to perform at least a portion of a data computing procedure or process. By way of example but not limitation, processing unit 218 may include one or more processors, controllers, microprocessors, microcontrollers, application specific integrated circuits, digital signal processors, programmable logic devices, field programmable gate arrays, and the like, or any combination thereof.

As shown in FIG. 2, processing unit 218 may be enabled to provide, in whole or part, one or more processes associated with the waveform correlation result processing provided herein. For example, processing unit 218 may be enabled to provide or otherwise support a peak reconstruction process 250. In certain implementations, processing unit 218 may also be enabled to provide or otherwise support an (optional) interpolation process 260, a detection process 270, and/or a C/Nₒ estimation process 280.

Memory 220 may be representative of any data storage mechanism. Memory 220 may include, for example, a primary memory and/or a secondary memory. Primary memory may include, for example, a random access memory, read only memory, etc. While illustrated in this example as being separate from processing unit 218, it should be understood that all or part of a primary memory may be provided within or otherwise co-located/coupled with processing unit 218. Secondary memory may include, for example, the same or similar type of memory as primary memory and/or one or more data storage devices or systems, such as, for example, a disk drive, an optical disc drive, a tape drive, a solid state memory drive, etc. In certain implementations, secondary memory may be operatively receptive of, or otherwise configurable to couple to, computer readable medium 240. Here, for example, computer readable medium 240 may include any media that can carry data and/or instructions.

Peak reconstruction process 250 may be enabled to provide or otherwise support a ‘chip×1’ search that may provide for a “fast scan” leading to other processes, such as, e.g., an SPS signal acquisition process. This may be beneficial, for example, in implementations where the total search space across all tasks in a queue may be larger than the search capacity allocated for that queue. For example, in certain implementations, a maximal chip×1 peak sample in an energy grid may be as large as half chip away from a real peak center, thus a loss of C/No estimation may be as significantly high (e.g., about 5 dB or more). However, in many implementations, accurate code phase estimation may not be required from a chip×1 search since a chip×2 search and/or the like may be subsequently conducted to provide higher accuracy. In certain example implementations, recovering off-peak sampling energy loss may allow for a C/No estimation that supports follow-on processing, such as, e.g., cross-correlation detection after the chip×1 search. As such, a more accurate C/No estimation may provide for strong valid signals which may reduce a need for some verify search processes, e.g., on cross-correlation peaks. Further, in certain examples, a more accurate C/No estimation for weak valid signals may prevent some valid peaks from being incorrectly filtered out as a cross-correlation peak. In this case, a sensitivity loss (Pₘᵢₛₛ) due to off-peak sampling may be reduced.

In certain example implementations, peak reconstruction process 250 may provide for sensitivity improvement since some of the peaks may be recovered prior to applying a noise threshold process.

Existing code phase domain interpolation processes may not be applicable to one-chip spaced samples. As mentioned, known code phase domain interpolation processes tend to use results from at least a chip×2 or higher sample rate search. Certain example Doppler domain interpolation processes may use energy samples from the same code phase bin, but from different Doppler bins, for example, with 25 Hz bin spacing. As provided herein, in certain implementations, a maximum likelihood based peak reconstruction process may be adapted to and/or otherwise be employed in a Doppler domain (e.g., with known Doppler domain pulse shape, and two energy samples from two neighboring Doppler bins).

In certain examples provided herein, peak reconstruction process 250 may used instead of (or in addition to) a code phase domain interpolation process such that the results from a chip×1 sample search may be used to provide a fast scan or other like capability. Here, for example, peak reconstruction process 250 may be selectively enabled to be carried out after or before a noise thresholding process. Thus, for example, some sensitivity gain may be achieved should peak reconstruction process 250 be carried out before a noise thresholding process. In certain example implementations, a noise thresholding process may be performed in advance of a peak reconstruction process 250.

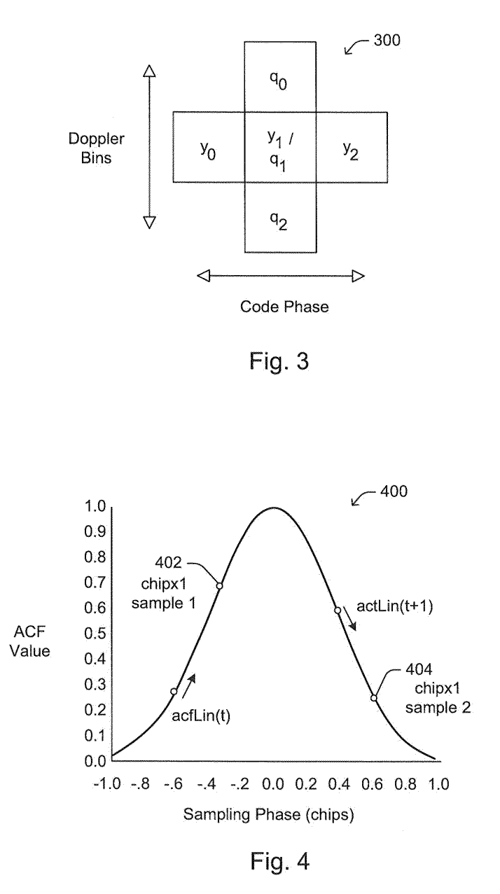

Attention is drawn next to FIG. 3, which illustrates a portion of a search grid 300 that may be considered by peak reconstruction process 250. Here, a five point cluster of peak energies is shown where the center energy represents the best peak detected in a grid. The row represents the Doppler bin containing the center energy, and the column represents the code phase bin containing the center energy. In the Doppler domain, one dimensional quadratic interpolation may be performed on the 3 energies (i.e., q₀,q₁,q₂) on the column, for example, using known techniques. Peak reconstruction process 250 may be implemented to provide for code phase domain reconstruction on the three one-chip space energies (y₀,y₁,y₂) Note that y₁=q₁.

Peak reconstruction process 250 may be enabled to compute the likelihood between the two best chip×1 energies on the row and two one-chip spaced samples chosen from the ACF curve. By way of example, FIG. 4 depicts curve 400 (linear) illustrating maximum likelihood detection on an example ACF as presented in an energy domain. As illustrated by the directional arrows in FIG. 4, in this example after normalization the two best chip×1 energies may be regarded as a first vector. Additionally, the two chip×1 samples 402 and 404 may form a second vector. The distance between these two vectors may be calculated. By moving the two chip×1 ACF samples along the ACF curve (e.g., hypothesis testing), peak reconstruction process 250 may determine a position on the ACF curve that minimizes the distance. This position on the ACF curve may be the estimated sampling phase for the chip×1 energies on the row. Since the sampling phase and ACF curve are known, peak reconstruction process 250 may combine the chip×1 energies on the row to obtain the peak height estimation.

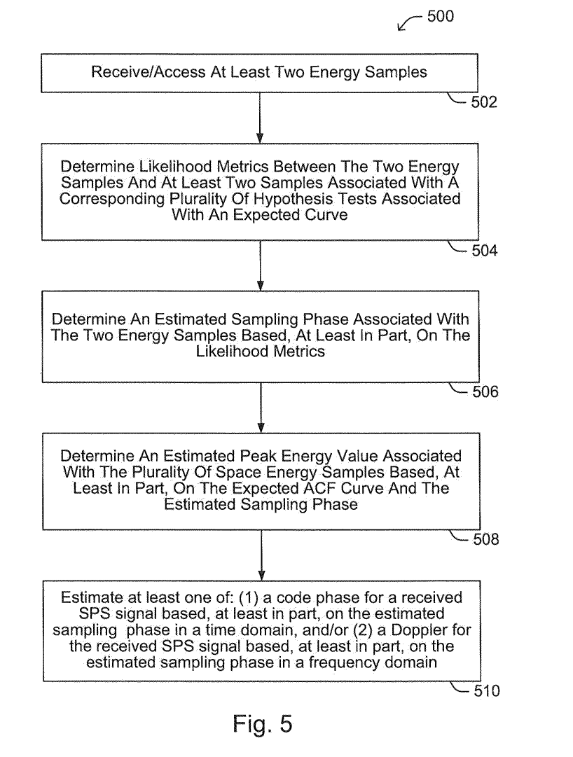

By way of example but not limitation, peak reconstruction process 250 may include all or portions of example method 500 as illustrated in FIG. 5. At block 502, a plurality of energy samples including at least two energy samples may be received and/or accessed. The energy samples may be sampled at a first rate (e.g., in either a time domain (code phase) and/or a frequency domain (Doppler) by the SPS receiver, for example, at a chip×1 rate. In a time domain an ACF may be used, and in a frequency domain “pulse shape” curve may be used. As described herein, therefore, the term “expected curve” should be interpreted where applicable to represent or otherwise be related to either an ACF or other like time domain curve/function, or a “pulse shape” or other like frequency domain curve/function.

By way of example, an ACF may refer to time-domain auto-correlation function of a GPS PRN code. A frequency domain “pulse shape” may refer to a GPS signal correlation with many single-frequency signals (e.g., Discrete Fourier Transform), for example. A “pulse shape” may, for example, relate to a plot of the correlation result versus frequency of a local single-frequency sine wave. In other words, an ACF may be a time domain correlation of a GPS signal with local PRN reference code, while a “pulse shape” may be a frequency domain correlation of a GPS signal with local sine wave.

At block 504, likelihood metrics may be determined based, at least in part, on the two energy samples and a plurality of at least two “expected curve” samples associated with a corresponding plurality of hypothesis tests associated with an expected curve for the SPS receiver. At block 506, an estimated sampling phase associated with the two energy samples may be determined, for example, based at least in part on one or more of the calculated likelihood metrics. At block 508, an estimated peak energy value associated with the energy samples may be determined, for example, based at least in part on the expected curve and the estimated sampling phase. In certain example implementations, at block 508, it may be selectively determined that the estimated peak energy value is to be provided as a reconstructed peak energy value for use in either detection or C/Nₒ estimation processes. Some example calculations for each of these types of reconstructed peak energy values are described in subsequent sections herein. At block 510, at least one of: (1) a code phase for a received SPS signal may be determined based, at least in part, on the estimated sampling phase in a time domain, and/or (2) a Doppler for the received SPS signal may be determined based, at least in part, on the estimated sampling phase in a frequency domain.

All or portions of the following example algorithm may be implemented as part of peak reconstruction process 250. For example, in the following numbered procedure, peak reconstruction process 250 may include one or more of acts (1) through (6). Additionally, acts (7) and/or (8) may be implemented in other processes and/or combined with a Doppler interpolation process. Some additional details (e.g., derivation details) are provided in subsequent sections.

In support of this example procedure, an ACF, acfLin(t), may be provided where 0≦t≦2. Here, one may center the ACF function at t=1 to simplify implementation. The ACF may be specifically established for the circuitry and/or other operative parameters in the SPS receiver. Further, a hypothesis spacing (e.g., hypothesis resolution), Δt, may be provided. By way of example but not limitation, in certain implementations the hypothesis resolution may be set it to be 0.1 SPS chip. Additionally, a mean predicted noise energy, in, may be established, for example, using known techniques. Also, a scale factor, peakDetScale, may be established for use in detection metric calculation, for example, to maintain a specific level of false alarms.

Inputs to this example procedure may include three chip×1 energies on the code phase domain, y₀,y₁,y₂, with y₁ being the max, and three energies, q₀,q₁,q₂ on the Doppler domain, with q₁ being the max and q₁=y₁.

An output from this example procedure may include a reconstructed peak energy for detection, \hat{P}_{Det}. In certain example implementations, such an output may (selectively) be used as a detection metric in peak processing, for example, where reconstruction prior to detection may be possible. An output from this example procedure may include a reconstructed peak energy for C/No estimation, \hat{P}_{Cno}. Another output from this example procedure may include a code phase estimation, ĈP.

Thus, such example procedure may include:
1. Calculate noise-unbiased energies, zᵢ=yᵢ−m, i=0,1,2
2. If z₀≦0 and z₂≦0, no need to reconstruct in code phase. Return with the original peak energy y₁.
3. Compare z₀ and z₂
4. If z₂>z₀, choose z₁ and z₂.
   (1) For i=1/Δt to i=1/(2Δt), (1−−), calculate

$$L ( i ) = \frac{{z}_{1} \cdot acfLin ( i Δ t ) + {z}_{2} \cdot acfLin ( i Δ t + 1 )}{\sqrt{{[ acfLin ( i Δ t ) ]}^{2} + {[ acfLin ( i Δ t + 1 ) ]}^{2}}}$$

(2) Choose the maximum of L(i), define it as Lₘₐₓ and define iₘₐₓ equal to the corresponding i.
(3) The reconstructed peak energy for detection is

\hat{P}_{Det}=Lₘₐₓ·peakDetScale+m
(4) The reconstructed peak energy for C/No estimation is

$${\hat{P}}_{Cno} = \frac{{L}_{max}}{\sqrt{{[ acfLin ( {i}_{max} Δ t ) ]}^{2} + {[ acfLin ( {i}_{max} Δ t + 1 ) ]}^{2}}} + m$$

5. Else, choose z₀ and z₁.
   (1) For i=1/Δt to i=3/(2Δt), (i++), calculate

$$L ( i ) = \frac{{z}_{0} \cdot acfLin ( i Δ t - 1 ) + {z}_{1} \cdot acfLin ( i Δ t )}{\sqrt{{[ acfLin ( i Δ t - 1 ) ]}^{2} + {[ acfLin ( i Δ t ) ]}^{2}}}$$

(2) Choose the maximum of L(i), define it as Lₘₐₓ and define iₘₐₓ equal to the corresponding i.
(3) The reconstructed peak energy for detection is

\hat{P}_{Det}=Lₘₐₓ·peakDetScale+m
(4) The reconstructed peak energy for C/No estimation is

$${\hat{P}}_{Cno} = \frac{{L}_{max}}{\sqrt{{[ acfLin ( {i}_{max} Δ t - 1 ) ]}^{2} + {[ acfLin ( {i}_{max} Δ t ) ]}^{2}}} + m$$

6. The estimated code phase position (in chips, or hypothesis, 1 chip=1 hypothesis for chip×1 search) is
7. ĈP=1−iₘₐₓΔt

Based on some computer simulations and analysis, in certain implementations, the example procedure presented above may be tailored in the following aspects:
(1) Hypothesis spacing Δt may set to be 0.1 SPS chip. Simulations tend to show that the C/No estimation using Δt=0.1 may not have significant performance degradation compared with Δt=0.01, in terms of C/No estimation error mean, sigma, min and max values. However, using Δt=0.2 may present significant performance degradation in some implementations. Some example performance information is presented in subsequent sections. The computation load of Δt=0.1 may only be 1/10 of Δt=0.01. Thus, setting Δt=0.1 chip may be adequate for code phase estimation, especially in implementations where a chip×1 or other like more precise search may follow an initial chip×1 search;
(2) Some or all of the ACF related values may be pre-computed and stored as constants, in certain implementations, for example, to avoid costly square root, division, and/or other like operations.

Table 1 (below) shows an example C/No estimation error for a chip×1 search and a chip×1 search with 20.0 ms X1 mode, true C/No=40 dB-Hz, and Doppler interpolation on, as produced via a computer simulation. Here, a computer simulated peak reconstruction procedure algorithm with a combined with Doppler interpolation procedure appears to be effective in recovering C/No loss in the chip×1 search. Similar results were seen for other modes as well.

TABLE 1

| C/No | | | | | |
|---|---|---|---|---|---|
| Estimation | Chipx1 Search | | | | |
| Error Mean | Bandwidth Reduction | | Bandwidth Reduction | | |
| across | Filter Bypassed | | Filter Enabled | | |
| Sampling | No Recon- | Recon- | No Recon- | Recon- | Chipx2 |
| Phases | struction | struction | struction | struction | Search |
| Average(dB) | −1.8 | −0.23 | −1.3 | −0.23 | −0.11 |
| Min (dB) | −0.06 | −0.02 | −0.1 | −0.05 | −0.04 |
| Max (dB) | −4.7 | −0.41 | −3.1 | −0.48 | −0.14 |

Table 2 (below) presents an example average C/No estimation error for more search types based on computer simulations.

TABLE 2

| Search | Chipx1 Search (No | Chipx1 Search | Chipx2 |
|---|---|---|---|
| types | reconstruction) | (Reconstruction) | Search |
| 10 × 2 | −1.73 dB | −0.40 dB | −0.21 dB |
| 10 × 50 | −1.41 dB | −0.37 dB | 0.11 dB |
| 20 × 100 | −1.44 dB | 0.19 dB | 0.16 dB |

Computer simulations appear to show that the code phase estimation error from chip×1 reconstruction may be within 0.1 chips (29.3 meters), with a mean of about 0.02 chips, sigma about 0.07 chips.

In certain implementations, for example, where a search mode employs chip×1 peak processing, it may be beneficial to consider implementing a peak reconstruction process prior to a noise thresholding process. For example, doing so may achieve sensitivity improvement in certain implementations, e.g., especially for a worst case scenario wherein sampling happens at about half chip away from a peak. However, a noise false alarm may increase, e.g., if the max log-likelihood metric (Lₘₐₓ+m) is directly used in a detection process. Without signal presence, the maximum among all noise-only cell energies in a grid may be selected. Here, such a maximum energy along with its neighbor cell energy may be input into the peak reconstruction process.

In certain example implementations, the reconstructed peak for detection may be chosen such that the noise false alarm rate stays at a desired (possibly same) level. For this purpose, Lₘₐₓ may be slightly scaled down to form the reconstructed peak for detection. By way of example but not limitation, certain computer simulations appear to show that a scale factor of 0.98 (−0.09 dB) may be suitable for integrations or other like search modes to maintain the false alarm rate for different sizes of search windows. Some computer simulations appear to show that a maximum of 0.8 dB sensitivity gain may be achieved for a half chip off-sampling case. An example numerical derivation of a maximum sensitivity gain is provided in subsequent sections.

For certain other example search modes, e.g., that employ chip×1 peak processing, it may not be as beneficial to perform a peak reconstruction process prior to a noise thresholding process (e.g., due to implementation complexity). Hence, it may be beneficial to consider applying a noise thresholding process for each cell in the energy grid before other processes. Doing so, may in certain implementations, reduce the number of peaks to consider following such tests and as such reduce processing burdens.

In the following section, a derivation of an example peak reconstruction procedure is provided.

Given the ACF is s(t)=acfLin(t), where −1≦t≦1, and the two largest energy samples from the 3 chip×1 energies samples are a and b, respectively. One may assume a is 1 chip ahead of b. The real peak energy is P, thus:

a=Ps(t)+N₁, and b=Ps(t+1)+N₂

where N₁ and N₂ are chi-square distributed random variables caused by noise. When non-coherent integration number is large, N₁ and N₂ can be closely approximated as Gaussian random variables with mean m and variance σ². The mean m is actually predicted mean background noise energy. The problem is now to best estimate unknown parameters P and t given that one knows a,b,m,σ². When using maximum likelihood estimation, the likelihood function of (a,b) is:

$${L}_{0} = \frac{1}{\sqrt{2 π} σ} exp \{ - \frac{{( a - m - Ps ( t ) )}^{2}}{2 {σ}^{2}} \} \cdot \frac{1}{\sqrt{2 π} σ} exp \{ - \frac{{( b - m - Ps ( t + 1 ) )}^{2}}{2 {σ}^{2}} \}$$

To maximize L₀, one may minimize:

L₁=(a−m−Ps(t))²+(b−m−Ps(t+1))²

Expanding L₁, provides:

$${L}_{1} = {( a - m )}^{2} + {( b - m )}^{2} + {P}^{2} {s}^{2} ( t ) + {P}^{2} {s}^{2} ( t + 1 ) - 2 ( a - m ) Ps ( t ) - 2 ( b - m ) Ps ( t + 1 )$$

$$\frac{\partial {L}_{1}}{\partial P} = 2 {Ps}^{2} ( t ) + 2 {Ps}^{2} ( t + 1 ) - 2 ( a - m ) s ( t ) - 2 ( b - m ) s ( t + 1 )$$

Setting

$$\frac{\partial {L}_{1}}{\partial P} = 0 ,$$

provides:

$$\hat{P} = \frac{( a - m ) s ( t ) + ( b - m ) s ( t + 1 )}{{s}^{2} ( t ) + {s}^{2} ( t + 1 )}$$

Substituting \hat{P} into L₁, provides:

$${L}_{1} = {( a - m )}^{2} + {( b - m )}^{2} - \frac{{[ ( a - m ) s ( t ) + ( b - m ) s ( t + 1 ) ]}^{2}}{{s}^{2} ( t ) + {s}^{2} ( t + 1 )}$$

One may then minimize L₁, by finding t=\dot{t}ₘₐₓ to maximize:

$$L ( t ) = \frac{( a - m ) s ( t ) + ( b - m ) s ( t + 1 )}{\sqrt{{s}^{2} ( t ) + {s}^{2} ( t + 1 )}}$$

In practice, one may start from t=−1 and then set a step size Δt, and calculate a series of L(t). Assume that one finds t=tₘₐₓ to maximize L(t).

The estimated peak (without predicted mean background noise energy bias) is thus:

$$\hat{P} = \frac{( a - m ) s ( {t}_{max} ) + ( b - m ) s ( {t}_{max} + 1 )}{{s}^{2} ( {t}_{max} ) + {s}^{2} ( {t}_{max} + 1 )}$$

This may be written as:

$$\hat{P} = \frac{L ( {t}_{max} )}{\sqrt{{s}^{2} ( {t}_{max} ) + {s}^{2} ( {t}_{max} + 1 )}}$$

In certain search modes, for example, an example peak reconstruction procedure may be carried out before noise thresholding to provide some sensitivity gain. When sampling at half chip off from the peak, this sensitivity gain appears to reach a maximum value, for example, as derived in the estimation below.

Assume X₁ and X₂ are the two chip×1 energy samples that are used in the reconstruction. X₁ is 0.5 chips ahead of the peak, and X₂ is 0.5 chips after the peak. Assume that they are both Gaussian distributed: X₁, X₂˜N(μ,σ²). Thus, for example:

μ=2Mσ₀²+Mμ₀², σ²=4Mσ₀⁴+4Mσ₀²μ₀²

Without running reconstruction, the peak energy used in detection is denoted by Y. Thus, for example:

Y=max(X₁,X₂)

The CDF and PDF of Y are:

F_{Y}(y)=P(Y≦y)=[F_{X}(y)]², p_{Y}(y)=2F_{X}(y)p_{X}(y)

An expected value of Y may be:

$$E [ Y ] = μ + \frac{σ}{\sqrt{π}} = ( 2 M {σ}_{0}^{2} + M {μ}_{0}^{2} ) + \sqrt{\frac{4 M {σ}_{0}^{4} + 4 M {σ}_{0}^{2} {μ}_{0}^{2}}{π}} \qquad ( 1 )$$

After running the peak reconstruction procedure, the reconstructed peak energy used in detection may be denoted by Z. Thus, for example:

$$Z = \frac{{s}_{1} ( {X}_{1} - 2 M {σ}_{0}^{2} ) + {s}_{2} ( {X}_{2} - 2 M {σ}_{0}^{2} )}{\sqrt{{s}_{1}^{2} + {s}_{2}^{2}}} + 2 M {σ}_{0}^{2}$$

Ideally, if the hypothesis test is correct every time, one should gets, s₁=s₂, then:

$$Z = \frac{\sqrt{2}}{2} ( {X}_{1} - 2 M {σ}_{0}^{2} ) + \frac{\sqrt{2}}{2} ( {X}_{2} - 2 M {σ}_{0}^{2} ) + 2 M {σ}_{0}^{2}$$

$$and$$

$$E [ Z ] = \sqrt{2} M {μ}_{0}^{2} + 2 M {σ}_{0}^{2}$$

With the peak reconstruction in place, the average increase in signal mean before detection may be:

$$\begin{matrix}Δ = \frac{E [ Z ] - 2 M {σ}_{0}^{2}}{E [ Y ] - 2 M {σ}_{0}^{2}} \\ = \frac{\sqrt{2} M {μ}_{0}^{2}}{M {μ}_{0}^{2} + \sqrt{\frac{4 M {σ}_{0}^{4} + 4 M {σ}_{0}^{2} {μ}_{0}^{2}}{π}}} \\ = \frac{\sqrt{2}}{1 + \frac{2}{\sqrt{M π}} \sqrt{\frac{{σ}_{0}^{2}}{{μ}_{0}^{2}} + \frac{{σ}_{0}^{4}}{{μ}_{0}^{4}}}}\end{matrix} \qquad ( 2 )$$

To better estimate this gain, one may use a better estimation of μ₀² at sensitivity. Also, when at sensitivity, the probability of s₁ not equal to s₂ is quite high. One may have to consider this factor when estimating (E[Z]−2Mσ₀²). In other words, E[Z]−2Mσ₀² may not be \sqrt{2}Mμ₀² any more. One may consider resorting to simulations to get better estimation of these numbers.

For 20×1, a 50% detection probability may achieved when setting C/No=34.4 dB-Hz. From computer simulations, μ₀²=530. Such simulation data then provides:

E[Z]−2Mσ₀²=765, and E[Y]−2Mσ₀²=646.

If using equation (1),

$$E [ Y ] - 2 M {σ}_{0}^{2} = {μ}_{0}^{2} + \sqrt{\frac{4 {σ}_{0}^{4} + 4 {σ}_{0}^{2} {μ}_{0}^{2}}{π}} = 650$$

This appears to be quite close to 646 from the example computer simulations.

The sensitivity improvement can thus be estimated as:

10 log₁₀(765/650)=0.72dB

One may roughly estimate the sensitivity gain using equation (2), such that:

$$\begin{matrix}Δ = \frac{\sqrt{2}}{1 + \frac{2}{\sqrt{M π}} \sqrt{\frac{{σ}_{0}^{2}}{{μ}_{0}^{2}} + \frac{{σ}_{0}^{4}}{{μ}_{0}^{4}}}} \\ = \frac{\sqrt{2}}{1 + \frac{2}{\sqrt{π}} \sqrt{\frac{20.65}{530} + {( \frac{20.65}{530} )}^{2}}} \\ = 0.62 dB\end{matrix}$$

Another factor that may affect sensitivity gain may be that the hypothesis test in the maximum likelihood detection appears to become much less reliable due to noise when C/No is at sensitivity. Simulations appear to show that at close to sensitivity, hypothesis test chooses the wrong sampling phase (e.g., at least 0.1 chips error) with a probability of 50%. Note that equation (2) does not consider that s₁ may not equal s₂ with some probability. To account for this issue, one may replace \sqrt{2} with 765/530=1.4434, thus the example sensitivity gain may be estimated as:

$$\begin{matrix}Δ = \frac{1.4434}{1 + \frac{2}{\sqrt{M π}} \sqrt{\frac{{σ}_{0}^{2}}{{μ}_{0}^{2}} + \frac{{σ}_{0}^{4}}{{μ}_{0}^{4}}}} \\ = \frac{1.4434}{1 + \frac{2}{\sqrt{π}} \sqrt{\frac{20.65}{530} + {( \frac{20.65}{530} )}^{2}}} \\ = 0.71 dB\end{matrix}$$

For 20×1 search, the estimated sensitivity improvement (0.71 dB) appears close to the simulation result (0.8 dB).

For 20×25 search, at sensitivity μ₀²=64 (from simulations), thus the estimated sensitivity improvement by using equation (2) is:

$$\begin{matrix}Δ = \frac{\sqrt{2}}{1 + \frac{2}{\sqrt{M π}} \sqrt{\frac{{σ}_{0}^{2}}{{μ}_{0}^{2}} + \frac{{σ}_{0}^{4}}{{μ}_{0}^{4}}}} \\ = \frac{\sqrt{2}}{1 + \frac{2}{\sqrt{25 π}} \sqrt{\frac{20.65}{64} + {( \frac{20.65}{64} )}^{2}}} \\ = 0.91 dB\end{matrix}$$

This also appears close to the sensitivity improvement (0.9 dB) seen from the simulations.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

What is claimed is:

1. A method for use in and/or with a Satellite Positioning System (SPS) receiver, the method comprising:
determining one or more likelihood metrics between at least two energy samples and at least two samples associated with a corresponding plurality of hypothesis tests associated with an expected curve for the SPS receiver, wherein a plurality of energy samples comprising at least said two energy samples are sampled at a first rate by the SPS receiver;
determining an estimated sampling phase associated with said at least two energy samples based, at least in part, on said one or more determined likelihood metrics;
determining an estimated peak energy value associated with said plurality of energy samples based, at least in part, on said expected curve and said estimated sampling phase; and
estimating at least one of: (1) a code phase for a received SPS signal based, at least in part, on said estimated sampling phase in a time domain, and/or (2) a Doppler for the received SPS signal based, at least in part, on said estimated sampling phase in a frequency domain.

2. The method as recited in claim 1, wherein said estimated peak energy value comprises a reconstructed peak energy value for use in detection.

3. The method as recited in claim 1, wherein said estimated peak energy value comprises a reconstructed peak energy value for use in C/Nₒ estimation.

4. The method as recited in claim 1, further comprising:
if said estimated peak energy value exceeds a minimum threshold value, providing said estimated peak energy value as a reconstructed peak energy value for use in C/Nₒ estimation.

5. The method as recited in claim 1, further comprising:
selectively determining said estimated peak energy value to provide a reconstructed peak energy value for use in either detection or C/Nₒ estimation.

6. The method as recited in claim 1, further comprising:
normalizing said at least two energy samples.

7. The method as recited in claim 1, further comprising:
adjusting said at least two energy samples based, at least in part, on a mean noise energy value.

8. The method as recited in claim 1, further comprising:
determining that at least one of said at least two energy samples exceeds a minimum threshold value before determining said likelihood metrics.

9. The method as recited in claim 1, wherein said at least two energy samples are associated with a code phase domain portion of a search grid comprising a cluster of energy samples that are also associated with Doppler bins.

10. The method as recited in claim 1, wherein said first rate comprises a chip×1 rate associated with a chip rate for an SPS signal.

11. The method as recited in claim 1, wherein, with respect to said time domain, said expected curve comprises an autocorrelation function (ACF) curve.

12. An apparatus for use in and/or with a Satellite Positioning System (SPS) receiver, the apparatus comprising:
memory having stored therein a plurality of energy samples, including at least two energy samples sampled at a first rate by the SPS receiver;
at least one processing unit operatively coupled to said memory and enabled to:
determine one or more likelihood metrics between the at least two energy samples and at least two samples associated with a corresponding plurality of hypothesis tests associated with an expected curve for the SPS receiver;
determine an estimated sampling phase associated with said at least two energy samples based, at least in part, on said one or more determined likelihood metrics;
determine an estimated peak energy value associated with said plurality of energy samples based, at least in part, on said expected curve and said estimated sampling phase; and
estimate at least one of: (1) a code phase for a received SPS signal based, at least in part, on said estimated sampling phase in a time domain, and/or (2) a Doppler for the received SPS signal based, at least in part, on said estimated sampling phase in a frequency domain.

13. The apparatus as recited in claim 12, wherein said estimated peak energy value comprises a reconstructed peak energy value for use in detection.

14. The apparatus as recited in claim 12, wherein said estimated peak energy value comprises a reconstructed peak energy value for use in C/Nₒ estimation.

15. The apparatus as recited in claim 12, wherein said at least one processing unit is operatively enabled to use said estimated peak energy value as a reconstructed peak energy value in C/Nₒ estimation if said estimated peak energy value exceeds a minimum threshold value.

16. The apparatus as recited in claim 12, wherein said at least one processing unit is operatively enabled to selectively determine said estimated peak energy value to provide a reconstructed peak energy value for use in either detection or C/Nₒ estimation.

17. The apparatus as recited in claim 12, wherein said at least one processing unit is operatively enabled to normalize said at least two energy samples.

18. The apparatus as recited in claim 12, wherein said at least one processing unit is operatively enabled to adjust said at least two energy samples based, at least in part, on a mean noise energy value.

19. The apparatus as recited in claim 12, wherein said at least one processing unit is operatively enabled to determine that at least one of said at least two energy samples exceeds a minimum threshold value before determining said likelihood metrics.

20. The apparatus as recited in claim 12, wherein said at least two energy samples are associated with a code phase domain portion of a search grid comprising a cluster of energy samples that are also associated with Doppler bins.

21. The apparatus as recited in claim 12, wherein said first rate comprises a chip×1 rate associated with a chip rate for an SPS signal.

22. The apparatus as recited in claim 12, wherein, with respect to said time domain, said expected curve comprises an autocorrelation function (ACF) curve.

23. An apparatus for use in and/or with a Satellite Positioning System (SPS) receiver, the apparatus comprising:
means for accessing a plurality of energy samples comprising at least two energy samples sampled at a first rate by the SPS receiver;
means for determining one or more likelihood metrics between at least two energy samples and at least two samples associated with a corresponding plurality of hypothesis tests associated with an expected curve for the SPS receiver, wherein a plurality of energy samples comprising at least said two energy samples are sampled at a first rate by the SPS receiver;
means for determining an estimated sampling phase associated with said at least two energy samples based, at least in part, on said one or more determined likelihood metrics;
means for determining an estimated peak energy value associated with said plurality of energy samples based, at least in part, on said expected curve and said estimated sampling phase; and
means for estimating at least one of: (1) a code phase for a received SPS signal based, at least in part, on said estimated sampling phase in a time domain, and/or (2) a Doppler for the received SPS signal based, at least in part, on said estimated sampling phase in a frequency domain.

24. The apparatus as recited in claim 23, wherein said estimated peak energy value comprises a reconstructed peak energy value for use in detection.

25. The apparatus as recited in claim 23, wherein said estimated peak energy value comprises a reconstructed peak energy value for use in C/Nₒ estimation.

26. The apparatus as recited in claim 23, further comprising:
means for providing said estimated peak energy value as a reconstructed peak energy value for use in C/Nₒ estimation if said estimated peak energy value exceeds a minimum threshold value.

27. The apparatus as recited in claim 23, further comprising:
selectively determining said estimated peak energy value to provide a reconstructed peak energy value for use in either detection or C/Nₒ estimation.

28. The apparatus as recited in claim 23, further comprising:
means for normalizing said at least two energy samples.

29. The apparatus as recited in claim 23, further comprising:
means for adjusting said at least two energy samples based, at least in part, on a mean noise energy value.

30. The apparatus as recited in claim 23, further comprising:
means for determining that at least one of said at least two energy samples exceeds a minimum threshold value before determining said likelihood metrics.

31. The apparatus as recited in claim 23, wherein said at least two energy samples are associated with a code phase domain portion of a search grid comprising a cluster of energy samples that are also associated with Doppler bins.

32. The apparatus as recited in claim 23, wherein said first rate comprises a chip×1 rate associated with a chip rate for an SPS signal.

33. The apparatus as recited in claim 23, wherein, with respect to said time domain, said expected curve comprises an autocorrelation function (ACF) curve.

34. An article comprising:
a computer readable medium having computer implementable instructions stored thereon which if implemented by one or more processing units in a specific apparatus that is for use in and/or with a Satellite Positioning System (SPS) receiver operatively enable the specific apparatus to:
access a plurality of energy samples, including at least two energy samples sampled at a first rate by the SPS receiver;
determine one or more likelihood metrics between the at least two energy samples and at least two samples associated with a corresponding plurality of hypothesis tests associated with an expected curve for the SPS receiver;
determine an estimated sampling phase associated with said at least two energy samples based, at least in part, on said one or more determined likelihood metrics;
determine an estimated peak energy value associated with said plurality of energy samples based, at least in part, on said expected curve and said estimated sampling phase; and
estimate at least one of: (1) a code phase for a received SPS signal based, at least in part, on said estimated sampling phase in a time domain, and/or (2) a Doppler for the received SPS signal based, at least in part, on said estimated sampling phase in a frequency domain.

35. The article as recited in claim 34, wherein said estimated peak energy value comprises a reconstructed peak energy value for use in detection.

36. The article as recited in claim 34, wherein said estimated peak energy value comprises a reconstructed peak energy value for use in C/Nₒ estimation.

37. The article as recited in claim 34, wherein said computer implementable instructions operatively enable the specific apparatus to use said estimated peak energy value as a reconstructed peak energy value in C/Nₒ estimation if said estimated peak energy value exceeds a minimum threshold value.

38. The article as recited in claim 34, wherein said computer implementable instructions operatively enable the specific apparatus to selectively determine said estimated peak energy value to provide a reconstructed peak energy value for use in either detection or C/Nₒ estimation.

39. The article as recited in claim 34, wherein said computer implementable instructions operatively enable the specific apparatus to normalize said at least two energy samples.

40. The article as recited in claim 34, wherein said computer implementable instructions operatively enable the specific apparatus to adjust said at least two energy samples based, at least in part, on a mean noise energy value.

41. The article as recited in claim 34, wherein said computer implementable instructions operatively enable the specific apparatus to determine that at least one of said at least two energy samples exceeds a minimum threshold value before determining said likelihood metrics.

42. The article as recited in claim 34, wherein said at least two energy samples are associated with a code phase domain portion of a search grid comprising a cluster of energy samples that are also associated with Doppler bins.

43. The article as recited in claim 34, wherein said first rate comprises a chip×1 rate associated with a chip rate for an SPS signal.

44. The article as recited in claim 34, wherein, with respect to said time domain, said expected curve comprises an autocorrelation function (ACF) curve.
